(19) United States
(12) Patent Application Publication
(10) Pub. No.: US 2001/0013290 A1
(43) Pub. Date: Aug. 16, 2001

(54) Machine for processing planar print carriers

(76) Inventors: Christian Hieb, Neuhofen (DE); Frank Gunschera, Nussloch (DE)

Correspondence Address: LERNER AND GREENBERG, P .A., PATENT ATTORNEYS AND ATTORNEYS AT LAW, Post Office Box 2480, Hollywood, FL, 33020-2480, US

(21) Appl. No.: 09/742,132

(22) Filed: Dec. 20, 2000

(30) Foreign Application Priority Data
Dec. 20, 1999 (DE) 199 61 883.6

(51) Int. Cl. B41F 5/02

(52) U.S. Cl. 101/232; 101/216

(57) ABSTRACT

A machine for processing planar print carriers having operationally rotating chains, and rails for guiding the chains, includes a damping covering arranged at least in sections along the rails and being clamped between two clamping surfaces, at least a first one of which is formed on the rails.

### BACKGROUND OF THE INVENTION

1. Field of the Invention

The invention relates to a machine for processing sheet-like print carriers, in particular a sheet-processing printing machine, with operationally rotating chains and with rails guiding these.

Chains have a multiplicity of uses as transmissions or as transporters and conveyors. In the case of machines for processing sheet-like print carriers, in particular, sheet-processing printing machines, they serve, among other things, for transporting printed sheets which, for example, are taken from a printing unit and fed to a delivery pile. For this purpose, in a chain delivery, two parallel endless chains are provided, which run, respectively, over a driving sprocket wheel and a deflecting or reversing sprocket wheel, the two driving sprockets and the two deflecting or reversing sprocket wheels, respectively, having a common axis of rotation. Mutually opposite special chain links of the two chains carry gripper systems with grippers, the latter closing automatically and being opened by suitable switching devices. The chains are guided, in particular, between the sprocket wheels by rails mounted on a stand of the printing machine.

Chain drives constructed in this manner cause a considerable amount of noise to be generated when the chains rotate at high speed, and the gripper systems carried thereby give rise, under the influence of changes in speed or in direction and of centrifugal forces in the region of the chain wheels, to alternating contacts of the chains with the rails, the latter thereby being set in vibration, resulting in sound being radiated at unpleasant frequencies and considerably loud.

Numerous proposed solutions have already become known heretofore for reducing chain running noises in chain drives. According to the published German Patent Document DE 39 39 250 A1, the chain running noises are reduced by providing the rails with a large radius of curvature. This, on the one hand, is not very effective and, on the other hand, takes up a great amount of space, and it is possible only to a limited extent to integrate such chain drives into a printing machine.

The published German Patent Document DE 195 13 420 A1 describes a chain drive, wherein a chain constructed as a roller chain has chain links which are inserted between conventional chain links and, respectively, replace two conventional chain links. These special chain links are each equipped with a supporting roller which is capable of rolling on one of two guide tracks located opposite one another, while chain rollers provided on the same chain link roll on the other of the two guide tracks. Thus, although displacements of the special chain links between the two guide tracks, which are caused by the dynamic operating conditions, for example, by centrifugal forces in curved sections of the guide tracks, the excitations to noise which are produced by the conventional first chain links remain largely unaffected.

Prior knowledge about a printing machine with a chain drive enclosed in a soundproof manner between walls may be derived from the published German Patent Document DE 34 23 272 A1. However, cladding of the chain drive such as is described therein, on the one hand, is complicated and costly and, on the other hand, requires additional ventilating devices for discharging heat and moisture.

### SUMMARY OF THE INVENTION

It is accordingly an object of the invention to provide a machine for processing planar print carriers which employs simple and cost-effective measures for reducing chain running noises.

With the foregoing and other objects in view, there is provided, in accordance with the invention, a machine for processing planar print carriers having operationally rotating chains, and rails for guiding the chains, comprising a damping covering or lining arranged at least in sections along the rails and being clamped between two clamping surfaces, at least a first one of which is formed on the rails.

In accordance with another feature of the invention, a second of the two clamping surfaces is formed on a frame carrying the rails.

In accordance with a further feature of the invention, the machine includes clamping plates arranged at least in sections along the rails and connected thereto with said damping covering being interposed and, simultaneously, put under pressure.

In accordance with an added feature of the invention, the rails have separating surfaces extending in the longitudinal direction thereof, the separating surfaces forming the clamping surfaces.

In accordance with an additional feature of the invention, the damping covering is formed of a soft-elastic material.

In accordance with yet another feature of the invention, the damping covering is formed of a viscoelastic material.

In accordance with yet a further feature of the invention, the damping covering is formed of one of an elastomeric plastic material and a polymer blend containing at least one elastomeric plastic material.

In accordance with yet an added feature of the invention, the damping covering is formed of a material having an elasticity modulus of between about 1 N/mm² and 1000 N/mm², depending upon the resonant frequency of the rail.

In accordance with yet an additional feature of the invention, the damping covering is formed of a material having a shear modulus of between about 0.4 N/mm² and 100 N/mm², depending upon the resonant frequency of the rail.

In accordance with a concomitant feature of the invention, the machine is a sheet-processing printing machine.

Thus, according to the invention, in the machine mentioned in the introduction hereto, the object of the invention is achieved by a damping covering which is arranged at least in sections along the rails and clamped between two clamping surfaces, at least a first of which is formed on the rails. By arranging the damping covering in accordance with the invention, an effective absorption of the rail vibrations induced by the chains and, consequently, an effective reduction in the chain running noises are assured. The arrangement of the damping covering under surface or contact pressure ensures that, in the event of vibrations of the rails, the latter is subjected not only to compressive and bending stress, but, in particular, also to shearing stress, thus resulting in a high vibration absorption capacity. The arrangement according to the invention of the damping covering is particularly effective also because vibrations are damped directly at the point where they originate.

The damping covering consists preferably of a soft-elastic or viscoelastic material. Depending upon the resonant frequency of the rails, the damping covering is produced with an elasticity modulus of preferably between 1 N/mm² and a 1000N/mm² and a shear modulus of preferably between 0.4 N/mm² and 100 N/mm². In this way, by a suitable choice of the material of the damping covering in terms of the E-modulus and G-modulus thereof, the maximum vibration absorption capacity of the damping covering can be adapted to the resonant frequency of the rails and, consequently, a marked reduction in the chain running noises can be achieved.

The damping covering may be formed, for example, of an elastomeric plastic material or a polymer blend containing at least one elastomeric plastic material.

Other features which are considered as characteristic for the invention are set forth in the appended claims.

Although the invention is illustrated and described herein as embodied in a machine for processing planar print carriers, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is an overall diagrammatic side elevational view of an embodiment of a sheet-processing machine in the form of an offset printing machine having, in accordance with the invention, operationally rotating chains forming a chain drive, and rails for guiding the chains;

FIG. 2 is a fragmentary cross-sectional view of FIG. 1 taken along the line A-A and rotated in part;

FIG. 3 is an enlarged fragmentary view of FIG. 2 showing another embodiment of the chain drive;

FIG. 4 is a view like that of FIG. 3 showing an alternative construction of the chain drive embodiment of FIG. 3;

FIG. 5 is a view like that of FIG. 3 showing a further embodiment of the chain drive; and

FIG. 6 is a view like that of FIG. 5 showing an alternative construction of the chain drive embodiment of FIG. 5.

### DESCRIPTION OF THE PREFERRED EMBODIMENTS

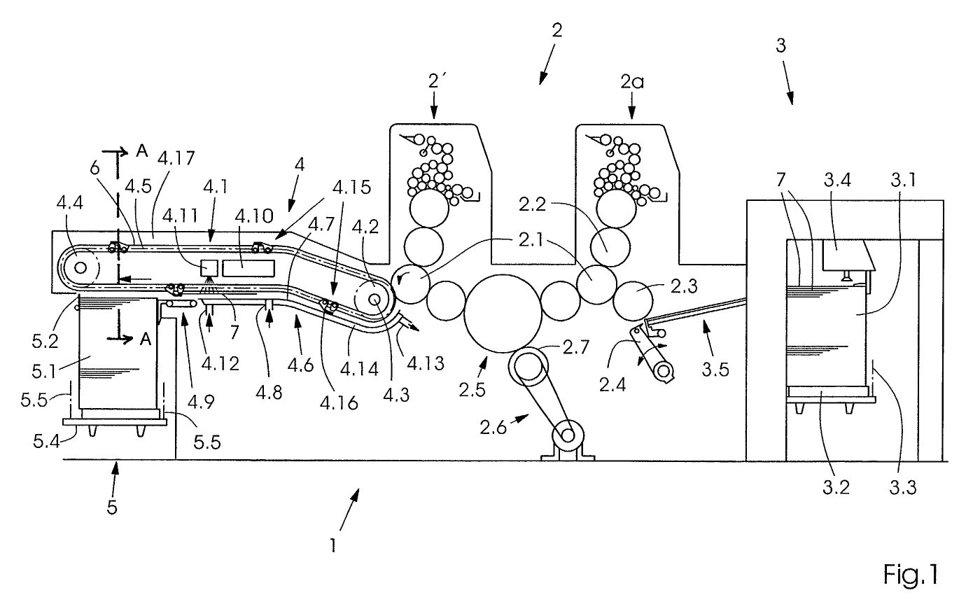

Referring now to the drawings and, first, particularly to FIG. 1 thereof, there is shown therein a sheet-processing machine 1, in an overall diagrammatic view. This machine 1 has a printing unit section 2, a paper feed device 3 in the form of a feeder, a delivery 4 with a chain drive 4.1 and a pile or stacking station 5 provided below the end region of the chain drive 4.1.

The paper feed device 3 has a platform 3.2 carrying a pile 3.1 formed of sheets 7. A lifting unit operating with lifting chains 3.3 is provided for raising the platform 3.2 in steps in accordance with the withdrawal of sheets 7 from the pile 3.1. Provided above the pile 3.1 is a separating or singling unit 3.4 with lifting and forwarding suckers for grasping the respectively uppermost sheet 7 of the pile 3.1 and for transferring that sheet 7 onto a transport and alignment unit 3.5 which includes a suction-belt conveyor and which aligns the sheets 7, respectively, at the leading edge and a lateral edge thereof for transfer purposes.

In the illustrated exemplary embodiment, the printing unit section 2 has two printing units 2a and 2′ operating by the offset method and is consequently constructed for the printing of two colors. In order to print further colors, another printing unit, respectively, must be provided for each color.

The printing unit 2a has an impression cylinder 2.1 and also a rubber blanket cylinder 2.2 co-operating therewith, and a feed drum 2.3 for transferring the sheet to be printed in the printing unit 2a onto the impression cylinder 2.1. The printing unit 2′ is equipped with corresponding devices. Between the transport and alignment units 3.5 and the feed drum 2.3, there is arranged a pregripper 2.4 which takes over a sheet 7 supplied and aligned by the transport and alignment unit 3.5 and transfers it onto the feed drum 2.3 which then transfers it onto the impression cylinder 2.1 of the first printing unit 2a.

A sheet transfer device 2.5 is provided between the printing units 2a and 2′. If two printing units connected by such a sheet transfer device print the same side of the sheet with different colors, the sheets are transferred thereby, unturned; insofar as two printing units connected by such a sheet transfer device, respectively, print another side of a sheet, the corresponding sheet transfer device is constructed in such a way that the sheets are transferred, turned, to the following printing unit.

For operation, a drive 2.6 is provided, with a belt drive driven by a motor and with a driving gearwheel 2.7 which is in engagement with a gearwheel of the sheet transfer device 2.5. In the illustrated embodiment, the chain drive 4.1 and the paper feed device 3 are also operatively connected to the drive 2.6, so that when the printing units 2a and 2′ are stopped, a stoppage or standstill of the other components involved in feeding sheets to the printing machine and in outputting sheets therefrom, respectively, occurs.

The printed sheets 7 are transferred to the chain drive 4.1 of the delivery 4, the chain drive 4.1 in this case being operatively connected to the drive 2.6. Driving sprocket wheels 4.2 tied into a gearwheel train of the printing machine are provided for this purpose.

The chain drive 4.1 includes two endless chains 4.5. The chains 4.5 run, respectively, along a side wall of the delivery 4, the side wall belonging to a frame of the printing machine, and are guided by a chain guide which is formed by rails 6 and which is described in further detail hereinbelow. One of the chains 4.5, respectively, loops about one of two driving sprocket wheels 4.2 which rotate synchronously during operation, the axes of rotation of which being in alignment, and, in the exemplary embodiment of FIG. 1, is guided over a deflecting or reversing sprocket wheel 4.4 arranged downline from and relative to the driving sprocket wheels 4.2, with respect to the processing direction. In the illustrated example of FIG. 1, the driving sprocket wheels 4.2 are seated on a common sprocket-wheel shaft 4.3. Between the two chains 4.5, there extend gripper systems 4.15 carried thereby and having grippers 4.16 which pass through gaps between grippers which are arranged on the impression cylinder 2.1 and, simultaneously, seizing a gripper edge of the leading end of a sheet 7, taking over the sheet 7 from the gripper arranged on the impression cylinder 2.1 immediately before the gripper is opened. In the example of FIG. 1, the sheets 7 are transported by the lower chain strand. The chain path section which the lower chain strand runs through is followed alongside by a sheet guide surface 4.7 which faces the chain path and is formed on a sheet guide unit 4.6. A supporting air cushion is preferably formed between the last-mentioned sheet guide surface and the sheet 7, respectively, guided thereover. For this purpose, the sheet guide unit 4.6 is equipped with blowing or blast air nozzles 4.8 which terminate in the sheet guide surface 4.7 and of which only one nozzle is reproduced in FIG. 1 as a symbolic illustration representing them in their entirety.

In order to prevent the printed sheets 7 from sticking to one another after being deposited in a pile, a drier 4.10 and a dusting or powdering device 4.11 are provided on the path of the sheets 7 from the driving sprocket wheels 4.2 to a sheet brake 4.9. To avoid excess heating of the sheet guide surface 4.7, the sheet guide unit 4.6 has a coolant circuit integrated therein which is indicated symbolically in FIG. 1 by an inlet connection piece 4.12 and an outlet connection piece 4.13 on a coolant tank 4.14 arranged on the sheet guide surface 4.7. The sheet brake 4.9 includes a plurality of brake modules which are, respectively, formed preferably by a suction belt conveyor.

The sheets 7 are transferred from the chain drive 4.1 to the stacking or pile station 5, so that a pile 5.1 of sheets 7 is formed in the latter. The stacking station 5 has, in an upper reception region thereof, a leading-edge stop 5.2 and an opposite trailing-edge stop 5.3 for the sheets 7, by which the sheets 7 are aligned. Furthermore, the stacking station 5 has a lifting unit, of which there is reproduced in FIG. 1 only a platform 5.4 carrying the pile 5.1, and lifting chains 5.5, represented by dot-dash lines, for carrying the platform 5.4.

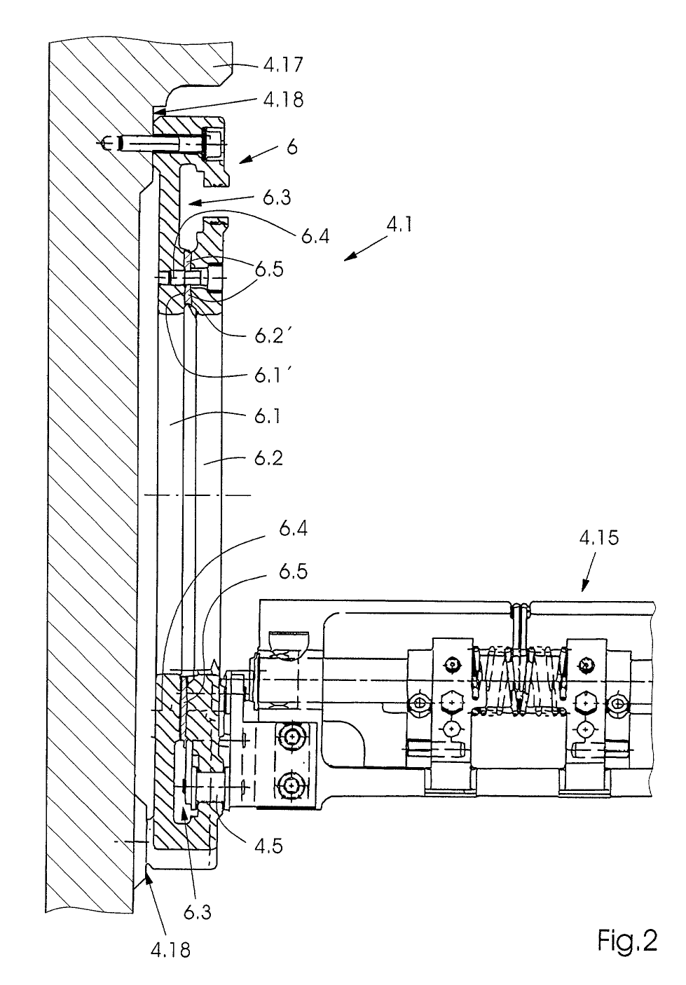

FIG. 2 illustrates only part of one of the synchronously guided endless chains 4.5 and one of the gripper systems 4.15 which is carried thereby, and which is reproduced herein in a rotated and truncated illustration. The chain 4.5 is guided by a rail 6 which, in the embodiment shown here, has a longitudinally divided construction, so as to form separating surfaces 6.1′ and 6.2′, and includes an outer guide member 6.1 and an inner guide member 6.2. The path of rotation of the chain 4.5 is limited outwardly by the outer guide member 6.1 and inwardly by the inner guide member 6.2, the guide members 6.1, 6.2 as a whole forming a substantially C-shaped guide profile 6.3 for the chain 4.5.

While the outer guide member 6.1 is screwed conventionally to raised bearing surfaces 4.18, which are machined to the required tolerances, of a side wall 4.17 of the delivery 4 (FIG. 1), the side wall belonging to a frame of the machine, the inner guide member 6.2 is screwed to the outer guide member 6.1, with an interposition of a damping covering 6.5 formed of a resilient, especially soft-elastic and/or viscoelastic, material, for example acrylic rubber. The damping covering 6.5 is disposed, under pressure, between the guide members 6.1 and 6.2, the pressure being built up by the screws 6.4 being tightened against non-illustrated stops. The separating surfaces 6.1′ and 6.2′ thus constitute clamping surfaces which are formed on the rail 6 and between which the damping covering 6.5 is clamped.

When the damping covering 6.5 is formed in one piece along the rail 6, the screws 6.4 pass through the damping covering 6.5. When the damping covering 6.5 is formed in a plurality of pieces, sections of the damping covering 6.5 which are arranged along the rail 6 between the screws 6.4 are provided. The adjustment of the inner guide member 6.1 relative to the outer guide member 6.2 is likewise performed by the screws 6.4 which, after adjustment has taken place, are secured against loosening (not illustrated).

A chain drive 4.1 with a rail 6 damped in this manner produces a reduction in the noise of the delivery 4 (FIG. 1) by an amount of 6 to 10 dB(A).

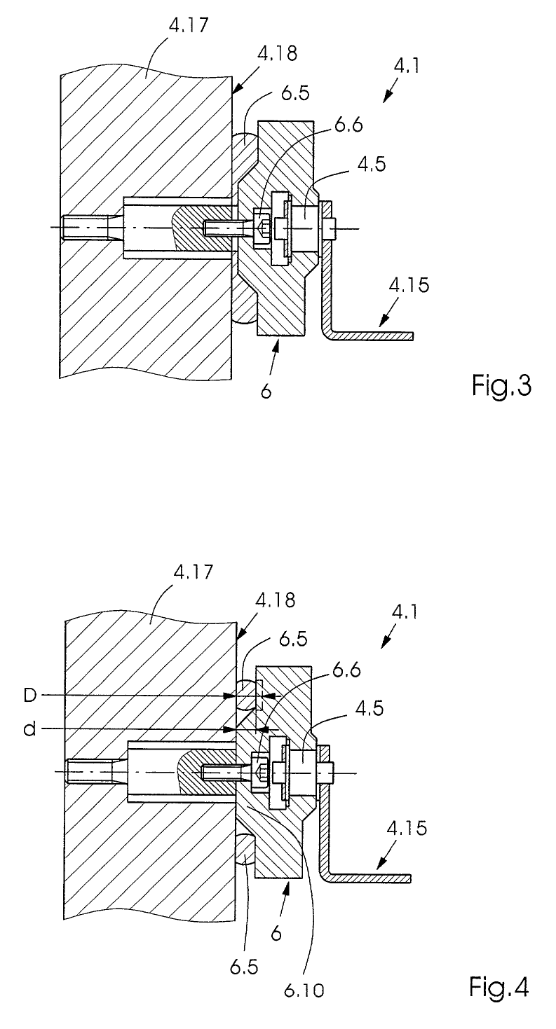

FIG. 3 shows part of a section taken along the line A-A in FIG. 1 of another preferred embodiment of the chain drive 4.1 with a rail 6 which here, by way of example, is unipartite and has a substantially C-shaped guide profile 6.3 for guiding the chain 4.5. Of the gripper system 4.15, only a fastening angle of the latter for articulation on one of the chains 4.5 is reproduced here. The rail 6 is fastened, via the intermediary of a damping covering 6.5 formed of a resilient, especially soft-elastic and/or viscoelastic material, for example acrylic rubber, by screws 6.6 to a bearing surface 4.18 of a side wall belonging to a frame of the machine. The damping covering 6.5 is disposed under pressure by being pressed between the rail 6 and the side wall 4.17, the pressure being capable of being set by the screws 6.6 and the adjustment of the rail 6 relative to the side wall 4.17 likewise being performed by the screws 6.6 which, in the adjusted state, are expediently secured against loosening. The damping covering 6.5 either is arranged in sections in the direction of the conveying chain 6.5 between the screws 6.6 or is produced in one piece and has the screws 6.6 passing therethrough, and in each case is clamped between two clamping surfaces, a first of which is formed on the rail 6, while a second thereof is represented by the bearing surface 4.18.

The alternate construction of the chain drive 4.1, as illustrated in FIG. 4, differs from the embodiment according to FIG. 3 in that the rail 6 is screwed, via adjusting extensions 6.10 on the latter, directly to the bearing surface 4.18 of the side wall 4.17, the rail 6 being adjusted automatically when the adjusting extensions 6.10 come to bear on the bearing surface 4.18. In the embodiment illustrated by way of example, the damping covering 6.5 clamped between the rail 6 and the side wall 4.17 is produced in one piece and is provided with perforations, through which the extensions 6.10 engage. The thickness D of the damping covering 6.5 in the untensioned state (indicated by dashes) at least slightly exceeds the thickness d of the extension 6.10, so that, in the assembled state, the damping covering 6.5 is under pressure and effectively damps the chain drive 4.1. The damping covering 6.5 is thus clamped again between two clamping surfaces, of which a first is formed on the rail 6 and a second is represented by the stop surface 4.18.

FIGS. 3 and 4 thus illustrate embodiments wherein, respectively, a first of the two clamping surfaces clamping the damping covering 6.5 is formed on the rail 6 and a second of these is formed on the side wall 4.17 belonging to a frame of the machine.

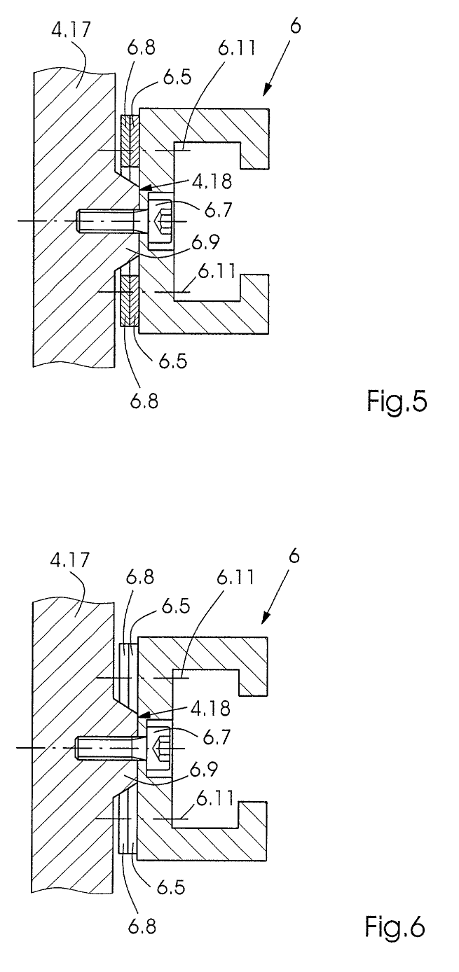

FIG. 5 illustrates a rail 6 which has a substantially C-shaped guide profile 6.3 for the chain 4.5 and which is fastened directly to raised fastening extensions 6.9 of the side wall 4.17 by screws 6.7. Specifically provided bearing surfaces 4.18 of the fastening extensions 4.9 are machined, in particular, to the required tolerances, so that the rail 6 is adjusted automatically when it comes to bear on the fastening extensions 6.9. In the example illustrated, in order to damp a respective rail 6, that side of the latter which faces away from the gripper systems 4.15 has applied thereto damping coverings 6.5 which, being put under pressure, are fastened, on the sides thereof facing away from the rails 6, to the rails by clamping plates 6.8 formed of a stretch-resistant material, for example metal or else plastic material. In the version shown, sections of the damping covering 6.5 and the clamping plates 6.8 extend between the extensions 6.9 and, with the damping covering 6.5 being put under pressure, are fastened to the rails 6 by screws 6.11, the pressure on the damping covering 6.5 being capable of being set by the screws 6.11.

As is believed to be clear from FIG. 6, the damping covering 6.5 and the clamping plates 6.8 may also extend beyond the fastening extensions 6.9. In this case, corresponding recesses are provided, through which the fastening extensions 6.9 engage.

We claim:

1. A machine for processing planar print carriers having operationally rotating chains, and rails for guiding the chains, comprising a damping covering arranged at least in sections along the rails and being clamped between two clamping surfaces, at least a first one of which is formed on the rails.

2. The machine according to claim 1, wherein a second of said two clamping surfaces is formed on a frame carrying the rails.

3. The machine according to claim 1, including clamping plates arranged at least in sections along the rails and connected thereto with said damping covering being interposed and, simultaneously, put under pressure.

4. The machine according to claim 1, wherein the rails have separating surfaces extending in the longitudinal direction thereof, said separating surfaces forming said clamping surfaces.

5. The machine according to claim 1, wherein said damping covering is formed of a soft-elastic material.

6. The machine according to claim 1, wherein said damping covering is formed of a viscoelastic material.

7. The machine according to claim 1, wherein said damping covering is formed of one of an elastomeric plastic material and a polymer blend containing at least one elastomeric plastic material.

8. The machine according to claim 1, wherein said damping covering is formed of a material having an elasticity modulus of between about 1 N/mm² and 1000 N/mm², depending upon the resonant frequency of the rail.

9. The machine according to claim 1, wherein said damping covering is formed of a material having a shear modulus of between about 0.4 N/mm² and 100 N/mm²₁ depending upon the resonant frequency of the rail.

10. The machine according to claim 1, wherein the machine is a sheet-processing printing machine.
